(19) United States
(12) Patent Application Publication
(10) Pub. No.: US 2014/0169468 A1
(43) Pub. Date: Jun. 19, 2014

(54) PICTURE REFRESH WITH CONSTANT-BIT BUDGET

(71) Applicant: LSI CORPORATION, Milpitas, CA (US)

(72) Inventors: Dariusz Dzik, Allentown, PA (US); George Kustka, Marlboro Twp., NJ (US)

(73) Assignee: LSI CORPORATION, Milpitas, CA (US)

(21) Appl. No.: 13/716,597

(22) Filed: Dec. 17, 2012

(51) Int. Cl. H04N 7/26

(52) U.S. Cl. CPC H04N 19/00696
USPC 375/240.16

(57) ABSTRACT

An apparatus having a memory and a circuit is disclosed. The memory may be configured to store multiple reference pictures. The circuit may be configured to (i) generate multiple compressed pictures by compressing each uncompressed picture using the reference pictures and a constant-bit budget and (ii) generate multiple new reference pictures in the memory by decompressing the compressed pictures. A subset of the compressed pictures may each be divided into a first area, a second area and a third area. The first areas are generally intra-encoded. Each motion vector of the second areas in the compressed pictures may point outside the third areas of the reference pictures. The first areas in the reference pictures that were decompressed from the subset of the compressed pictures may incorporate content from the third areas.

### FIELD OF THE INVENTION

The present invention relates to video encoding generally and, more particularly, to a method and/or apparatus for implementing picture refresh with a constant-bit budget.

### BACKGROUND OF THE INVENTION

An H.264 Advanced Video Coder (i.e., H.264) standard introduced a high compression efficiency coding technique. Under H.264, video frames can be coded as intra-frames, as predicted frames, as bidirectional predicted frames or as “skipped” frames. An intra-frame contains complete image data for the frame and so does not rely on image data from other frames. An intra-frame is used at the beginning of a video sequence and commonly at each scene change. The intra-frames are helpful in restoring the image after image data is lost or corrupted due to transmission problems or other factors. Hence, the intra-frames are also used periodically to help restore quality in a decoding process. Intra-frame encoding provides the lowest compression performance. Therefore, intra-frames are avoided under strict transmission bit budgets because the average intra-frame utilizes between 2 to 8 times as many bits compared with predicted frames, depending on video material and coding method. When intra-frames are used only for an initial frame; recovery from a lost or corrupted frame takes many frames to restore the decoded video to an expected quality level.

It would be desirable to implement picture refresh with a constant-bit budget.

### SUMMARY OF THE INVENTION

The present invention concerns an apparatus having a memory and a circuit. The memory may be configured to store multiple reference pictures. The circuit may be configured to (i) generate multiple compressed pictures by compressing each uncompressed picture using the reference pictures and a constant-bit budget and (ii) generate multiple new reference pictures in the memory by decompressing the compressed pictures. A subset of the compressed pictures may each be divided into a first area, a second area and a third area. The first areas are generally intra-encoded. Each motion vector of the second areas in the compressed pictures may point outside the third areas of the reference pictures. The first areas in the reference pictures that were decompressed from the subset of the compressed pictures may incorporate content from the third areas.

The objects, features and advantages of the present invention include providing picture refresh with a constant-bit budget that may (i) implement an H.264 codec, (ii) refresh corrupted areas in decoded video without the bit-cost of a full intra-coded frame, (iii) maintain a constant-bit budget, (iv) generate an intra-coded refresh area in each picture, (v) modify motion vectors to avoid corrupted areas, (vi) reduce the time taken to refresh corrupted areas without a significant bit penalty and/or (vii) be implemented in an integrated circuit.

### BRIEF DESCRIPTION OF THE DRAWINGS

These and other objects, features and advantages of the present invention will be apparent from the following detailed description and the appended claims and drawings in which:

FIG. 1 is a block diagram of an example video system;

FIG. 2 is a diagram of an example compressed picture at the start of a refresh cycle;

FIG. 3 is a diagram of an example intermediate compressed picture;

FIG. 4 is a diagram of an example compressed picture at an end of the refresh cycle;

FIG. 5 is a block diagram of an example implementation of an apparatus;

FIG. 6 is a functional block diagram of a video digital processor circuit in accordance with a preferred embodiment of the present invention;

FIG. 7 is a diagram of an example compressed picture J;

FIG. 8 is a diagram of an example compressed picture K;

FIG. 9 is a diagram of an example compressed picture L;

FIG. 10 is a diagram of an example compressed picture N+K

FIG. 11 is a diagram of an example arrangement of a set of macroblocks used in a deblocking operation; and

FIG. 12 is a diagram of an example arrangement of a set of macroblocks used in an intra-prediction Operation.

### DETAILED DESCRIPTION OF THE PREFERRED EMBODIMENTS

Some embodiments of the present invention may provide a technique and structure for video encoding. The technique generally intra-codes macroblocks in form of “refresh line” (or lines or area). The technique may also modify a motion estimation to avoid potentially corrupted (or dirty) areas of the video to speed-up the intra-refresh without a significant bit penalty.

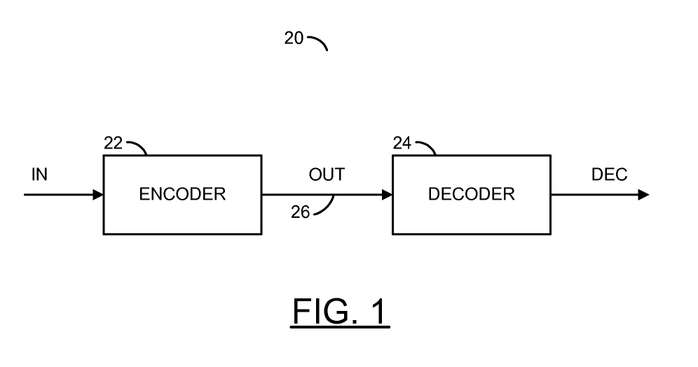

Referring to FIG. 1, a block diagram of an example video system 20 is shown. The system 20 may implement a video encoder/decoder system. The system 20 generally comprises a block (or circuit) 22, a block (or circuit) 24 and a medium (or link) 26. An input signal (e.g., IN) is received by the circuit 22. An output signal (e.g., OUT) is generated by the circuit 22 and transferred to the circuit 24 via the medium 26. The circuit 24 may generate and present a decoded signal (e.g., DEC).

The signal IN generally carries uncompressed and unencoded video. The signal IN may be one or more analog video signals and/or one or more digital video signals. The signal IN generally comprises a sequence of progressive-format frames and/or interlace-format fields. The signal IN may include synchronization signals suitable for synchronizing the video information. The signal IN may be presented in analog form as, but not limited to, an RGB (Red, Green, Blue) signal, an EIA-770 (e.g., YCrCb) signal, an S-video signal and/or a Composite Video Baseband Signal (CVBS). In digital form, the signal IN may be presented as, but is not limited to, a High Definition Multimedia Interface (HDMI) signal, a Digital Video Interface (DVI) signal and/or a BT.656 signal. The signal IN may be formatted as a standard definition signal or a high definition signal.

The signal OUT conveys compressed and encoded video. The signal OUT may be a compressed and encoded digital video signal, generally referred to as a bitstream. The signal OUT may comprise a sequence of progressive-format frames and/or interlace-format fields. The signal OUT may be compliant with a VC-1, MPEG and/or H.26x standard. The MPEG/H.26x standards generally include H.263, H.264, MPEG-1, MPEG-2 and MPEG-4. The MPEG standards may be defined by the Moving Pictures Expert Group, International Organization for Standards, Geneva, Switzerland. The H.26x standards may be defined by the International Telecommunication Union-Telecommunication Standardization Sector, Geneva, Switzerland. The VC-1 standard may be defined by the document Society of Motion Picture and Television Engineer (SMPTE) 421M-2006, by the SMPTE, White Plains, N.Y.

The signal DEC may carry uncompressed and unencoded video, similar to that in the signal IN. The signal DEC may be one or more analog video signals and/or one or more digital video signals. The signal DEC generally comprises a sequence of progressive-format frames and/or interlace-format fields. The signal DEC may include synchronization signals suitable for synchronizing the video information. The signal DEC may be presented in analog form as, but not limited to, an RGB (Red, Green, Blue) signal, an EIA-770 (e.g., YCrCb) signal, an S-video signal and/or a Composite Video Baseband Signal (CVBS), In digital form, the signal DEC may be presented as, but is not limited to, a High Definition Multimedia Interface (HDMI) signal, a Digital Video Interface (DVI) signal and/or a BT.656 signal. The signal DEC may be formatted as a standard definition signal or a high definition signal.

The circuit 22 generally implements a video encoder circuit. The circuit 22 is operational to compress and encode the raw video received in the signal IN. The compressed and encoded video is presented in the signal OUT. The compression and encoding may be compliant with the H.264 codec standard. Other video code standards may be implemented to meet the criteria of a particular application.

The circuit 24 generally implements a video decoder circuit. The circuit 24 is operational to decode and decompress the video data received in the signal OUT. The decoded and decompressed video is presented in the signal DEC. The decoding and decompression may be compliant with the H.264 codec standard.

Other video code standards may be implemented to meet the criteria of a particular application.

The medium 26 generally implements one or more transmission media and/or one or more storage media. The medium 26 is operational to transfer and/or store the video data in the signal OUT from the circuit 22 to the circuit 24. In practical implementations, the medium 26 sometimes introduces errors while transferring/storing the video data. The errors often range from flipping individual bits to losses of one or more complete pictures (or frames or fields or images).

Consider case where transfer of the video data from the circuit 22 to the circuit 24 results in some of the video data becoming polluted, corrupted or lost. The polluted, corrupted or lost video data usually leads to temporary quality issues in the decompressed video in the signal DEC. Since decompressed pictures are commonly used to generate new reference pictures in the circuit 24, an error in a decompressed picture may propagate through subsequent reference pictures.

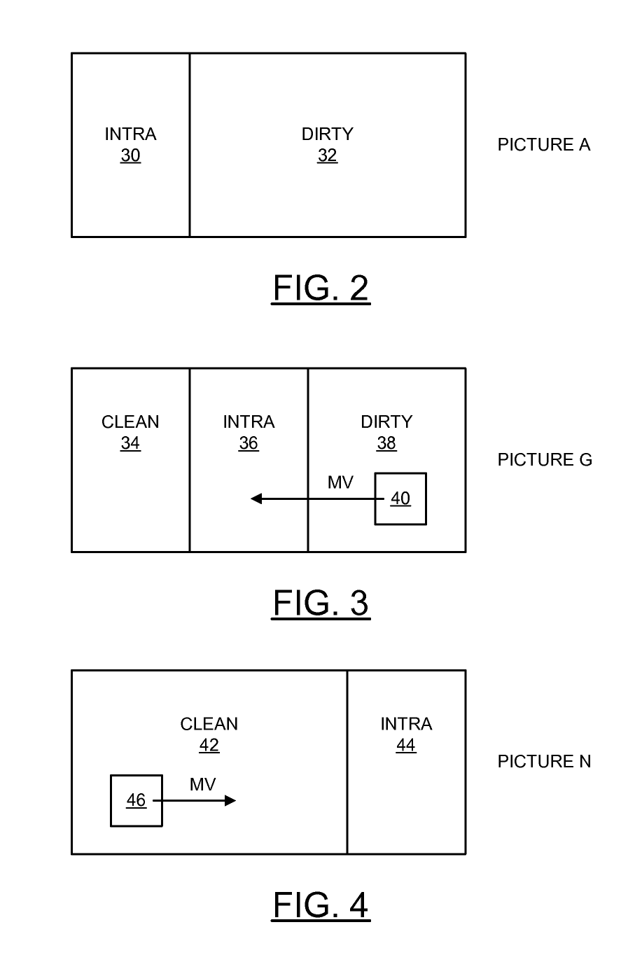

Referring to FIG. 2, a diagram of an example compressed picture A within the circuit 24 at the start of a refresh cycle is shown. The picture A has multiple (e.g., two) areas: an intra area 30 and a dirty area 32. The picture A may be an initial picture of the refresh cycle (or sequence) spanning multiple (e.g., N) pictures.

A leftmost column or multiple columns of macroblocks in the picture A (e.g., within the intra area 30) are generally encoded as intra-macroblocks. A remainder of the picture A (e.g., within the dirty area 32) may be encoded normally using inter-macroblocks (e.g., predicted macroblocks and/or bidirectional macroblocks) as well as intra-macroblocks. The macroblocks in the dirty area 32 are considered to contain errors (e.g., are “dirty”) possibly due to pollution (or corruption or losses) while being transferred from the circuit 22 to the circuit 24. In the picture A, no restriction may be imposed on the encoding operations in the circuit 22 in terms of motion prediction, macroblock types and/or macroblock partitioning.

Referring to FIG. 3, a diagram of an example intermediate compressed picture G within the circuit 24 is shown. The picture G has multiple (e.g., three) areas: a clean area 34, an intra area 36 and a dirty area 38. The picture G is an intermediate picture of the refresh cycle. The picture G may be temporally later than the picture A.

In some situations, a motion vector (e.g., MV) of an inter-predicted macroblock (or block) 40 in the dirty area 38 of the current picture G may be estimated as normal during encoding. Therefore, the motion vector may point to a location within the dirty areas, the intra areas and possibly into the clean areas of one or more reference pictures (e.g., the intra area 30 and the dirty area 32 of the picture A when the picture A is used as a reference picture). In other situations, the range of some to all motion vectors being estimated may be limited by the encoding operations in the circuit 22 to point into the clean areas and/or the intra areas of the reference pictures. For example, the motion vectors of macroblocks in the clean area 34 of the current picture G may be limited to the clean areas and/or the intra areas of the reference pictures (e.g., the intra area 30 of the picture A when the picture A is used as a reference picture to encode and decode the current picture G). To account for reference pictures more than a single inter-picture temporal distance from the current picture being encoded/decoded, the intra areas may be repeated in the same location for several sequential pictures before being moved to the next location. Thus, all available reference pictures for encoding/decoding the current picture may have co-located clean areas, co-located intra areas and co-located dirty areas. Avoiding motion estimations into the dirty areas of the reference pictures generally helps reduce error propagation from picture-to-picture through the reference pictures.

Referring to FIG. 4, a diagram of an example compressed picture N at the end of the refresh cycle within the circuit 24 is shown. The picture N has multiple (e.g., two) areas: a clean area 42 and an intra area 44. The picture N may be a final picture of the refresh cycle. The picture N may be temporally later than the picture G. A motion vector of an inter-predicted macroblock 46 in the clean area 42 of the picture N may be limited to point into the clean areas and/or intra areas of one or more reference pictures (e.g., the clean area 34 and/or the intra area 36 in the picture G when the picture G is used as a reference picture to encode and decode the current picture N) to reduce the picture-to-picture error propagation.

The pictures A-N generally differ from each other in that the intra areas of the later pictures A-N are in different locations (e.g., moved to the right) than the intra areas of the earlier pictures A-N. A rate at which the intra areas are moved depends on a number of reference pictures and a number of intra-macroblock columns used in the encode operation. Typical cases are below and other cases may be extrapolated from the examples:

Case 1—A single reference picture with the intra area a single macroblock wide:

Picture A: intra area located in column 1 (e.g., a leftmost column);

Picture B: intra area located in column 2;

Picture C: intra area located in column 3;

Picture N: intra area located in column X (e.g., a rightmost column).

Case 2—a single reference picture with the intra area two macroblocks wide:

Picture A: intra area located in columns 1 . . . 2 (e.g., two leftmost columns);

Picture B: intra area located in columns 3 . . . 4;

Picture C: intra area located in columns 5 . . . 6;

. . .

Picture N: intra area located in columns X−1 . . . X (e.g., two rightmost columns).

Case 3—a single reference picture with the intra area three macroblocks wide:

Picture A: intra area located in columns 1 . . . 3 (e.g., three leftmost columns);

Picture B: intra area located in columns 4 . . . 6;

Picture C: intra area located in columns 7 . . . 9;

Picture N: intra area located in columns X−2 . . . X (e.g., three rightmost columns).

Case 4—two reference pictures with the intra areas a single macroblock wide:

Picture A: intra area located in column 1 (e.g., a leftmost column);

Picture B: intra area located in column 1 (e.g., a leftmost column);

Picture C: intra area located in column 2;

Picture D: intra area located in column 2;

. . .
Picture N−1: intra area located in column X (e.g., a rightmost column).

Picture N: intra area located in column X (e.g., a rightmost column)

Case 5—two reference pictures with the intra area two macroblocks wide:

Picture A: intra area located in columns 1 . . . 2 (e.g., two leftmost columns)

Picture B: intra area located in columns 1 . . . 2 (e.g., two leftmost columns)

Picture C: intra area located in columns 3 . . . 4

Picture D: intra area located in columns 3 . . . 4

. . .

Picture N−1: intra area located in columns X−1 . . . X (e.g., two rightmost columns)

Picture N: intra area located in columns X−1 . . . X (e.g., two rightmost columns).

When the intra-macroblock column(s) move in a sequence of compressed pictures A-N (e.g., move to the right), the regions that the intra-macroblock column(s) departed from (e.g., to the left) are generally considered the clean areas. Restrictions may be introduced in the motion estimations to minimize or avoid content in the dirty areas of the reference pictures from influencing (or corrupting) the macroblocks in the clean areas of subsequent decoded pictures. In some situations, any type of macroblock and block partition may be allowed for macroblocks in the clean areas of the compressed pictures (e.g., block 46 in FIG. 4). In other situations, motion predictions for macroblocks in the clean areas (e.g., block 46 in FIG. 4) of the compressed pictures may limit the motion vectors to the intra areas and the clean areas of the reference pictures (e.g., the intra area 36 and the clean area 34 of the picture G when the picture G is used as a reference picture for the current picture N during encoding and decoding). In still other situations, the motion predictions for the macroblocks in the clean areas (e.g., block 46 in FIG. 4) may limit the motion vectors to the clear areas of the reference pictures (e.g., the clean area 34 of the picture G when the picture G is used as a reference picture for the current picture N).

To avoid corrupting a clean-area macroblock during encoding, motion vector search ranges may be restricted in the circuit 22. Consider a case where the intra areas are a single macroblock wide. In some embodiments, the rightmost column of macroblocks in the clean area of a picture being compressed may have the horizontal components of the motion vectors limited to zero to the right (e.g., co-located with the intra area of the nearest reference picture) for integer-per (integer-pixel) predictions. For half-pel predictions, the horizontal search range may be limited to −4 pixel distances to the right (e.g., restricted 4 pixel distances to the left of the intra area-dirty area boundary in the nearest reference picture). The −4 horizontal restriction generally avoids searching in regions where dirty area pixels will be used by the circuit 24 to synthesize the half-pel pixels of the nearest reference picture during a decode operation. The second rightmost column of macroblocks in the clean area may have the horizontal components of the motion vector limited to 16 pixel distances to the right for the integer-pel predictions and to 12 pixel distances to the right for the half-pel predictions. The third rightmost column of macroblocks may have the horizontal components of the motion vectors limited to 32 pixel distances to the right for the integer-pel predictions and to 28 pixel distances to the right for the half-pel predictions, and so on.

In some embodiments, the search range to the right of the macroblocks (e.g., the macroblock 46 in the picture N) being encoded by the circuit 22 may be limited to one side of a boundary in the reference picture (e.g., the boundary between the intra area 36 and the dirty area 38 in the picture G when the picture G is used as a reference picture) for the integer-pel, the half-pel, the quarter-pel and the eighth-pel motion predictions. In such situations, some corrupted pixels in the dirty areas of the reference pictures may be used by the circuit 24 to generate the sub-pel (e.g., half-pel, quarter-pel and eighth-pel) pixels used to reconstruct the predicted macroblocks. Therefore, some error propagation may take place from one reference picture into another reference picture during the decode operations.

Apparent motion of the intra areas may be other than left-to-right across the pictures. A shape of the inter areas may be other than a straight line. In some embodiments, the intra areas may be horizontal lines sequentially located from top-to-bottom across the pictures. In other embodiments, the intra areas may be slopped. In still other embodiments, the intra areas may be moved in a nonlinear manner. In some embodiments, the intra areas may comprise multiple areas located in various patterns during the refresh cycle.

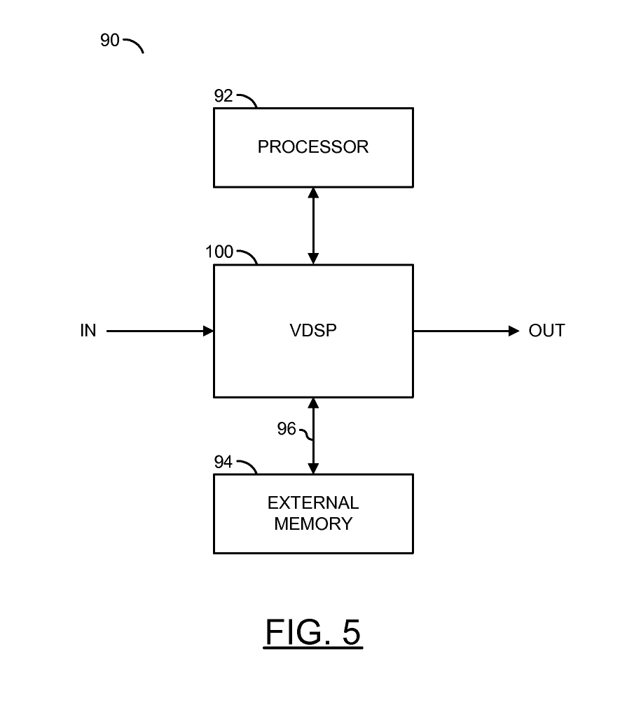

Referring to FIG. 5, a block diagram of an example implementation of an apparatus 90 is shown. The apparatus (or circuit or device or integrated circuit) 90 may implement a video encoder. The circuit 90 may be configured to implement the refresh line technique with restricted motion estimations. The apparatus 90 generally comprises a block (or circuit) 92, a block (or circuit) 94, a bus (or circuit) 96 and a block (or circuit) 100. The circuits 92-100 may represent modules and/or blocks that may be implemented as hardware, software, a combination of hardware and software, or other implementations.

The circuit 100 may be directly coupled with the circuit 92 to exchange data and control information. The circuit 100 may be coupled with the circuit 94 to exchange data. An input signal (e.g., IN) may be received by the circuit 100. An output bitstream signal (e.g., OUT) may be presented by the circuit 100.

The circuit 92 generally implements as a processor. The circuit 92 is operational to perform select digital video encoding operations. The encoding may be compatible with the VC-1, MPEG or H.26x standards. The circuit 92 may also be operational to control the circuit 100. In some embodiments, the circuit 92 implements a SPARC processor. In other embodiments, the circuit 92 implements an ARM processor. Other types of processors may be implemented to meet the criteria of a particular application. The circuit 92 is typically fabricated as an integrated circuit in (on) a single chip (or die).

The circuit 94 may be implemented as a dynamic random access memory (e.g., DRAM). The circuit 94 may be operational to store or buffer large amounts of information consumed and generated by the encoding operations of the apparatus 90. As such, the circuit 94 may be referred to as a main (or external) memory. The circuit 94 may be implemented as a double data rate (e.g., DDR) memory. Other memory technologies may be implemented to meet the criteria of a particular application. The circuit 94 may be fabricated as an integrated circuit in (on) a single chip (or die). In some embodiments, the circuits 92 and 94 may be fabricated in (on) separate chips.

The circuit 96 may implement a memory bus. The bus 96 is generally operational to carry data, address and commands between the circuit 100 and the circuit 94. The bus 96 generally includes a data bus having a width of multiple bits (e.g., 128 bits).

The circuit 100 may be implemented as a video digital signal processor (e.g., VDSP) circuit. The circuit 100 may be operational to perform additional digital video encoding operations. The circuit 100 may be controlled by the circuit 92. The circuit 100 generally comprises multiple digital signal processors (or cores).

Encoding operations performed by the circuit 100 may include, but are not limited to the following. While encoding a sequence of pictures received via the signal IN, the circuit 100 may store multiple reference pictures in the memory circuit 94. The circuit 100 may generate multiple compressed pictures by compressing each of a sequence uncompressed pictures in the signal IN using the reference pictures buffered in the circuit 94 and a constant-bit budget. A subset of the compressed pictures (e.g., the pictures B-M) may each be divided into an intra area, a clean area and a dirty area. An initial picture (e.g., the picture A) may be divided into the intra area and the dirty area. Another picture (e.g., the picture N) may be divided into the intra area and a clean area. The macroblocks in the intra areas may be intra-encoded. Some to all of the macroblocks in the clean areas and the dirty areas being may be inter-encoded. Each motion vectors of inter-coded macroblocks in the clean areas of the compressed pictures may point outside the dirty areas of the reference pictures. The circuit 100 may also generate new reference pictures in the circuit 94 by decompressing the compressed pictures. The intra areas in the reference pictures decompressed from the subset of the compressed pictures may incorporate some dirty content from the dirty areas.

The circuit 100 may be fabricated as an integrated circuit in (on) a single chip (or die). In some embodiments, the circuits 92 and 100 may be fabricated in (on) the same chip. In other embodiments, the circuits 92 and 100 may be fabricated in (on) separate chips.

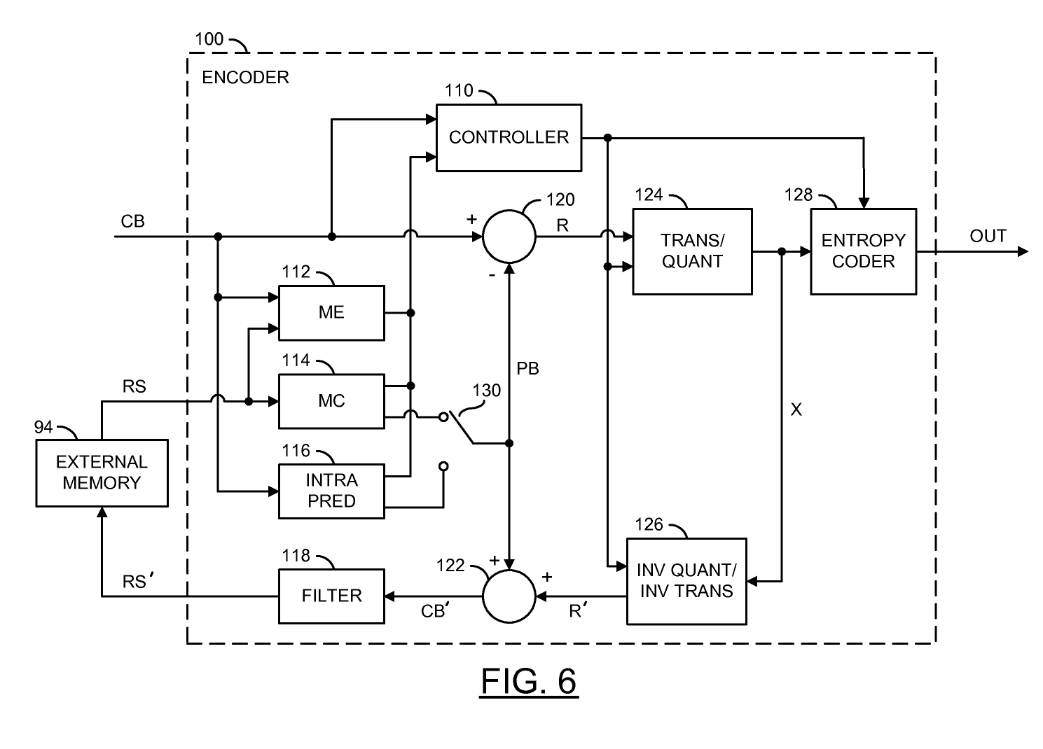

Referring to FIG. 6, a functional block diagram of the circuit 100 in accordance with a preferred embodiment of the present invention is shown. The encoder circuit 100 generally comprises a controller step (or function) 110, a motion estimation (e.g., ME) step (or function) 112, a motion compensation (e.g., MC) step (or function) 114, an intra-prediction step (or function) 116, a filter step (or function) 118, an adder step (or function) 120, another adder step (or function) 122, a transform/quantization step (or function) 124, an inverse quantize/inverse transform step (or function) 126, an entropy coder step (or function) 128 and a switch step (or function) 130. The circuit 100 may implement a hybrid video codec. The steps 110-130 may be implemented as hardware, software or a combination of hardware and software.

A signal (e.g., CB) may be received by the controller step 110, the ME step 112, the intra-prediction step 116 and the adder step 120. The signal CB may carry a current block from the signal IN that is being encoded. The signal OUT may be generated by the entropy coder step 128. The MC step 114 and the ME step 112 may receive reference picture data from the memory circuit 94 in a signal (e.g., RS). The filter step 118 may generate and transfer new reference pictures to the memory circuit 94 in a signal (e.g., RS′). A residual signal (e.g., R) may be generated by the adder step 120 and transferred to the transform/quantization step 124. The signal R may convey residual information produced by subtracting picture blocks from prediction blocks. The transform/quantization step 124 may generate and transfer a signal (e.g., X) to the entropy coder step 128 and the inverse quantization/inverse transform step 126. The signal X may carry the transformed and quantized data representative of the residual blocks. A residual signal (e.g., R′) may be generated by the inverse quantize/inverse transform step 126 and presented to the adder step 122. The signal R′ may carry reconstructed residual information. A prediction signal (e.g., PB) may be generated by the MC step 114 or the intra-prediction step 116, depending on the encoding mode. The signal PB generally carries the prediction blocks used by the adder steps 120 and 122. The signal PB may be routed from one of the steps 114 or 116 to the adder steps 120 and 122 by the switch step 130. A reconstructed signal (e.g., CB′) may be generated by the step 122 and transferred to the step 118. The signal CB′ may convey reconstructed blocks, similar to the blocks received in the signal CB. A reference signal (e.g., RS′) may be generated by the step 118 and transferred to the circuit 94. The signal RS′ may carry reconstructed reference blocks used to create the reference pictures.

The control step 110 may implement an encoding control function. The step 110 is generally operational to control encoding of the video signal. The video signal generally comprises multiple interlaced fields and/or multiple progressive frames.

The ME step 112 may implement a motion estimation function. The step 112 is generally operational to estimate a motion between a current block of a current picture (or field or frame) and a closest matching block in a reference picture (or field or frame). The estimated motion may be expressed as a motion vector that points from the current block to the closest matching reference block. The reference picture may be earlier or later in time than the current picture. The reference picture may be spaced one or more temporal inter-picture distances from the current picture. Each pixel of a picture may be considered to have a luminance (sometimes called “luma” for short) value (or sample) and two chrominance (sometimes called “chroma” for short) values (or samples). The motion estimation is generally performed using the luminance samples.

The MC step 114 may implement a motion compensation function. The step 114 is generally operational to calculate a motion compensated (or predicted) block based on the reference samples received in the signal RS and a motion vector received from the step 112. Calculation of the motion compensated block generally involves grouping a block of reference samples around the motion vector where the motion vector has integer-pel (or pixel or sample) dimensions. Where the motion vector has sub-pel dimensions, the motion compensation generally involves calculating interpolated reference samples at sub-pel locations between the integer-pel locations. The sub-pel locations may include, but are not limited to, half-pel locations, quarter-pel locations and eighth-pel locations. The motion compensated block may be presented in the signal PB.

The intra-prediction step 116 may implement an inter-prediction function. The step 116 is generally operational to calculate intra-predicted blocks from other blocks internal to the current picture. The intra-predicted blocks may be presented in the signal PB.

The filter step 118 may implement a spatial filter function. The step 118 is generally operational to spatially filter the reconstructed blocks received in the signal CB′. The filter blocks may be presented as new reference blocks to the circuit 94 in the signal RS′.

The adder step 120 may implement an addition function. The step 120 is generally operational to create residual blocks by adding an inverse of (or subtracting) the motion compensated blocks from the current blocks. The differences may be calculated on a sample-by-sample basis where each sample in a motion compensated block is subtracted from a respective current sample in a current block to calculate a respective residual sample (or element) in a residual block. The residual blocks may be presented in the signal R.

The adder step 122 may implement an adder function. The step 122 may be operational to add the reconstructed residual samples received via the signal R′ to the predicted samples received via the signal PB to generate reconstructed current samples. The reconstructed current samples may be presented in the signal CB′ to the filter step 118.

The transform step 124 may implement transformation and quantization functions. The step 124 is generally operational to transform the residual samples in the residual blocks into transform coefficients. The step 124 may also be operational to quantize the transform coefficients. The resulting coefficients may be presented in the signal X to the step 128 and the step 126.

The inverse quantization/inverse transform step 126 may implement inverse quantization and inverse transformation functions. The step 126 is generally operational to inverse quantize the coefficients received in the signal X to calculate reconstructed transform coefficients. The step 126 may also be operational to inverse transform the reconstructed transform coefficients to calculate reconstructed residual samples. The step 126 may reverse the quantization and transformation functions performed by the step 124. The reconstructed residual samples may be transferred to the step 122 in the signal R′.

The entropy coder step 128 may implement an entropy encoder function. The step 128 is generally operational to entropy encode a string of reordered symbols and syntax elements that represent the resulting quantized transform coefficients, motion vectors, encoding modes and other data. The encoded information may be presented in the signal OUT.

The switch step 130 may implement a switching function. The step 130 may be operational to route the predicted blocks from the step 116 while the step 110 has selected intra-prediction. The step 130 may also be operational to route the motion compensated prediction blocks from the step 114 while the step 110 has selected inter-prediction.

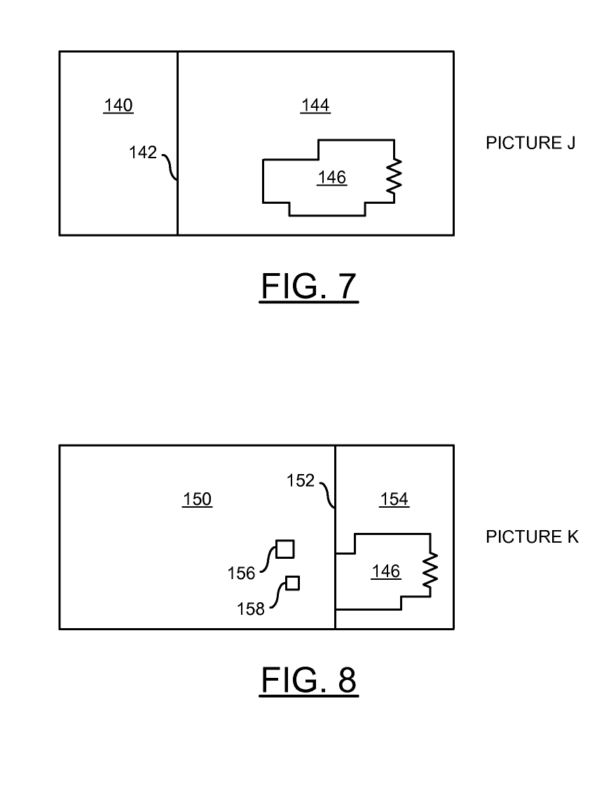

Referring to FIG. 7, a diagram of an example compressed picture J within the circuit 24 is shown. The picture J generally has multiple (e.g., three) areas: a clean area 140, an intra area 142 and a dirty area 144. A corrupted (or polluted or erroneous) region 146 may exist in the dirty area 144 of the picture J.

Referring to FIG. 8, a diagram of an example compressed picture K within the circuit 24 is shown. The picture K generally has multiple (e.g., three) areas: a clean area 150, an intra area 152 and a dirty area 154. The picture K may be temporally later than the picture J.

Part of the corrupted region 146 may still exist in the picture K. As the intra areas traverse the pictures, the intra areas may refresh (or correct) the corrupted region 146. In some embodiments, the intra areas may refresh the corrupted region 146 in a single pass. In other embodiments, the intra areas may leave behind some still-corrupted regions (e.g., 156 and 158) after a single pass.

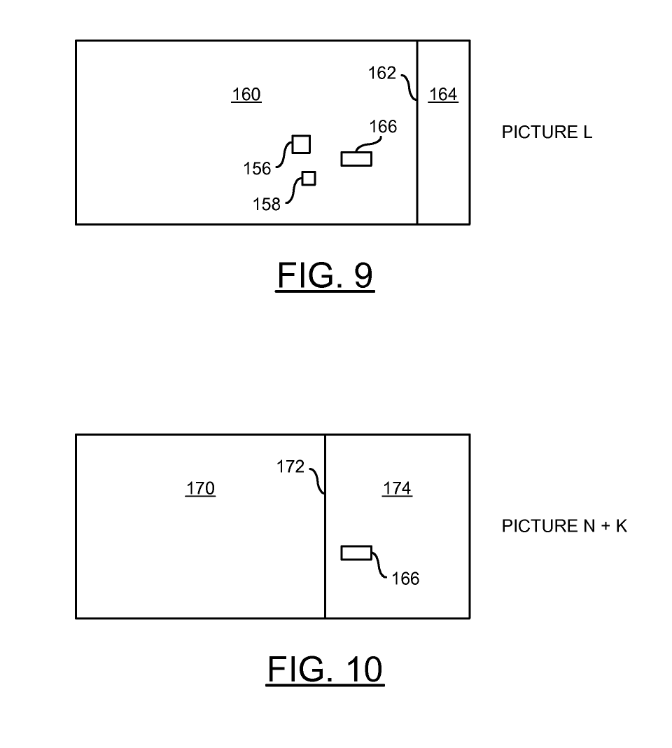

Referring to FIG. 9, a diagram of an example compressed picture L within the circuit 24 is shown. The picture L generally has multiple (e.g., three) areas: a clean area 160, an intra area 162 and a dirty area 164. The picture L may be temporally later than the picture K.

In the picture K, the intra areas have moved across and refreshed the corrupted region 146 once. In some embodiments, the initial refresh cycle may leave behind some still-corrupted regions 156, 158 and 166 due spreading from the corrupted region 146 into subsequent decoded pictures.

Referring to FIG. 10, a diagram of an example compressed picture N+K within the circuit 24 is shown. The picture N+K generally has multiple (e.g., three) areas: a clean area 170, an intra area 172 and a dirty area 174. The picture N+K may be temporally later than the picture L.

The circuit 22 may begin a new refresh sequence once the current refresh sequence has ended. For example, the circuit 22 may place the intra area in the leftmost column of a picture N+1 after the intra area has reached the rightmost column in the picture N. The next refresh cycle generally begins with the picture N+1 and ends with a picture 2N. As shown in FIG. 10, the intra area 172 may eliminate the corrupted regions 156 and 158 during the next refresh cycle. In some situations, three or more refresh cycles may be utilized to remove a corrupted region.

Corrupted content (e.g., pixels) from the dirty areas may pollute the content in the clean areas due to one or more normal operations performed while decoding the compressed pictures in the circuit 24. The operations may include, but are not limited to, an image smoothing filter (e.g., deblocking) operation, an intra-prediction operation and a motion compensation operation. In some embodiments, the pollution may be considered as visually irrelevant and so may be allowed to occur. For example, pollution caused by an in-loop deblocking filter may have a minor visual impart on the decoded pictures that may be fully removed after two to four refresh cycles.

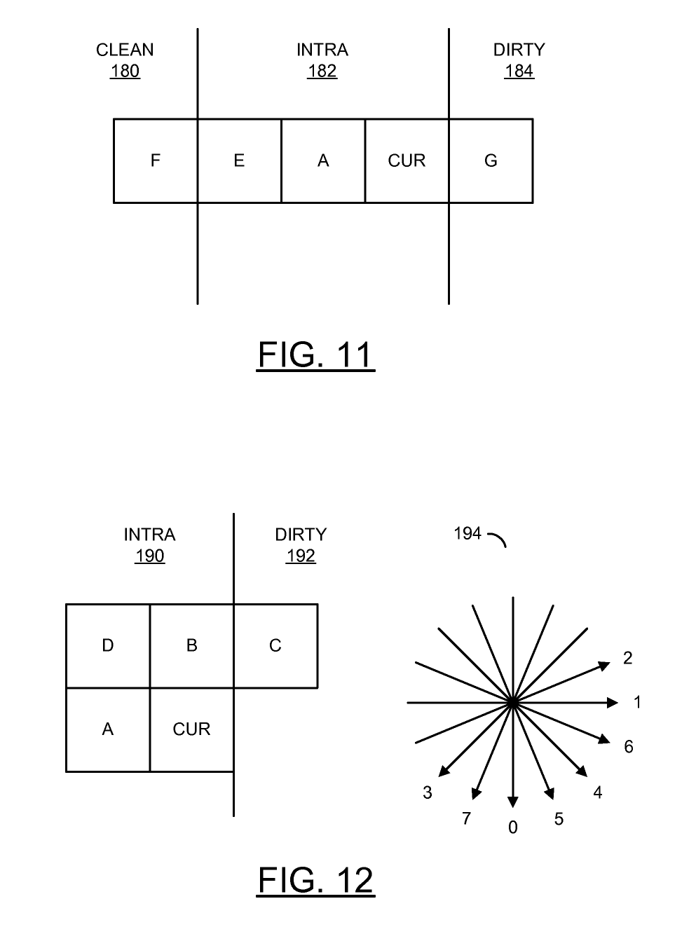

Referring to FIG. 11, a diagram of an example arrangement of a set of macroblocks used in a deblocking operation is shown. Reconstructed macroblocks A, CUR (e.g., current), E, F and G may be spatially filtered before being stored as part of a new reference picture in a main memory. The spatial filtering may cause some blending between the adjacent pixels of adjoining macroblocks. For example, the adjacent pixels of (i) the macroblocks E and F, (ii) the macroblocks E and A, (iii) the macroblocks A and CUR and (iv) the macroblocks CUR and G may be spatially filtered together in a deblocking operation. Since the macroblock sets (i) F and E, (ii) E and A and (iii) A and CUR are in the clean area 180 and the intra area 182, the spatial filtering may produce normal results. The macroblock G may be in the dirty area 184. When the dirty macroblock G is spatially filtered with the intra block CUR, some polluted content may propagate from the dirty macroblock G into the filtered macroblock CUR. The resulting filtered macroblock CUR may be used as part of a new reference picture and thus some corruption may remain, although in a diminished form.

Referring to FIG. 12, a diagram of an example arrangement of a set of macroblocks used in an intra prediction operation are shown. Macroblocks A, CUR, B and D may reside in an intra area 190. A macroblock C may reside in a dirty area 192. Multiple intra-prediction directions 194 are defined in the H.264 standard. When the circuit 24 decodes the intra-macroblock CUR from a compressed picture, if the intra-prediction direction is 2, 1, 6, 4, 5 or 0, content (e.g., pixels) in the neighboring intra-macroblocks A, B and D may be used to reconstruct the macroblock CUR. If the intra-prediction direction is 3 or 7, the dirty content in the neighboring dirty macroblock C may be used to reconstruct the macroblock CUR. Therefore, some polluted content from the dirty macroblock C may be spread to the macroblock CUR.

Once the macroblocks A, B, C, D and CUR have been reconstructed and become part of a new reference picture, the macroblocks A, B, C, D and CUR may be used in motion compensation operations by the circuits 22 and 24. For example, a motion vector of a predicted macroblock in a next picture may point to a half-pel location between the macroblocks B and C. When the motion compensation operation in the circuit 24 calculates the pixels at the half-pel locations, a multi-tap filter in the motion compensation operation may use some dirty pixels from the dirty macroblock C. As such, the newly created half-pel pixels in the circuit 24 may include some pollution from the macroblock C.

Afterwards, the polluted half-pel pixels may be used to reconstruct new “clean” macroblocks.

Some embodiments of the invention may encode intra-macroblocks into the form of a refresh line using the encoder circuit 22. Some embodiments may also modify the motion estimation operation of the circuit 22 to limit the motion vectors to clean areas and intra areas of the reference frames. The compressed pictures generated by the circuit 22 may have an approximately constant-bit budget. Using standard decoding operations, the decoder circuit 24 may decode the compressed pictures. Because of the way that the compressed pictures were encoded by the circuit 22, any corruption of the compressed pictures experienced in transition from the circuit 22 to the circuit 24 may be quickly removed (e.g., typically in one or two refresh cycles) in the circuit 24.

The functions performed by the diagrams of FIGS. 1-12 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
a memory configured to store a plurality of reference pictures; and
a circuit configured to (i) generate a plurality of compressed pictures by compressing each of a plurality of uncompressed pictures using said reference pictures and a constant-bit budget and (ii) generate a plurality of new ones of said reference pictures in said memory by decompressing said compressed pictures, wherein (a) a subset of said compressed pictures are each divided into a first area, a second area and a third area, (b) said first areas are intra-encoded, (c) each of a plurality of motion vectors of said second areas in said compressed pictures point outside said third areas of said reference pictures and (d) said first areas in said reference pictures decompressed from said subset of said compressed pictures incorporate content from said third areas.

2. The apparatus according to claim 1, wherein said circuit is further configured to move said first areas among different locations within a sequence of said reference pictures to refresh each viewable location at least once in said sequence.

3. The apparatus according to claim 1, wherein said compressing utilizes said constant-bit budget independently of a decoder configured to decompress said compressed pictures.

4. The apparatus according to claim 1, wherein said first areas are generated in said compressed pictures independently of a decoder configured to decompress said compressed pictures.

5. The apparatus according to claim 1, wherein said circuit is further configured to filter said reference pictures prior to storage in said memory, said filtering causing a portion of said first areas to incorporate said content from said third areas.

6. The apparatus according to claim 1, wherein (i) said first area comprises a line of blocks and (ii) said line has a width of two or more of said blocks.

7. The apparatus according to claim 1, wherein said circuit is further configured to reconstruct said first areas of said reference pictures by intra-prediction, said intra-prediction causing a portion of said first areas in some of said reference pictures to incorporate said content from said third areas.

8. The apparatus according to claim 1, wherein said circuit is further configured to generate a plurality of motion compensated blocks that incorporate said content from said third areas.

9. The apparatus according to claim 8, wherein said circuit is further configured to reconstruct a plurality of inter-coded blocks of said reference pictures using said motion compensated blocks.

10. The apparatus according to claim 1, wherein said apparatus is implemented as one or more integrated circuits.

11. A method for picture refresh with a constant-bit budget, comprising the steps of:
(A) storing a plurality of reference pictures in a memory;
(B) generating a plurality of compressed pictures by compressing each of a plurality of uncompressed pictures using said reference pictures and said constant-bit budget, (i) a subset of said compressed pictures each being divided into a first area, a second area and a third area, (ii) said first areas being intra-encoded and (iii) each of a plurality of motion vectors of said second areas in said compressed pictures point outside said third areas of said reference pictures; and
(C) generating a plurality of new ones of said reference pictures in said memory by decompressing said compressed pictures, wherein said first areas in said reference pictures decompressed from said subset of said compressed pictures incorporate content from said third areas.

12. The method according to claim 11, further comprising the step of:
moving said first areas among different locations within a sequence of said reference pictures to refresh each viewable location at least once in said sequence.

13. The method according to claim 11, wherein said compressing utilizes said constant-bit budget independently of a decoder configured to decompress said compressed pictures.

14. The method according to claim 11, wherein said first areas are generated in said compressed pictures independently of a decoder configured to decompress said compressed pictures.

15. The method according to claim 11, further comprising the step of:
filtering said reference pictures prior to storage in said memory, said filtering causing a portion of said first areas to incorporate said content from said third areas.

16. The method according to claim 11, wherein (i) said first area comprises a line of blocks and (ii) said line has a width of two or more of said blocks.

17. The method according to claim 11, further comprising the step of:
reconstructing said first areas of said reference pictures by intra-prediction, said intra-prediction causing a portion of said first areas in some of said reference pictures to incorporate said content from said third areas.

18. The method according to claim 11, further comprising the step of:
generating a plurality of motion compensated blocks that incorporate said content from said third areas.

19. The method according to claim 18, further comprising the step of:
reconstructing a plurality of inter-coded blocks of said reference pictures using said motion compensated blocks.

20. An apparatus comprising:
means for storing a plurality of reference pictures;
means for generating a plurality of compressed pictures by compressing each of a plurality of uncompressed pictures using said reference pictures and a constant-bit budget, (i) a subset of said compressed pictures each being divided into a first area, a second area and a third area, (ii) said first areas being intra-encoded and (iii) each of a plurality of motion vectors of said second areas in said compressed pictures point outside said third areas of said reference pictures; and
means for generating a plurality of new ones of said reference pictures in said means for storing by decompressing said compressed pictures, wherein said first areas in said reference pictures decompressed from said subset of said compressed pictures incorporate content from said third areas.
